(19) United States
(12) Patent Application Publication
(10) Pub. No.: US 2008/0142505 A1
(43) Pub. Date: Jun. 19, 2008

(54) Low simmer heating element with mechanical switches

(75) Inventor: Manfred W. Staebler, New Bern, NC (US)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Home Appliances Corporation, Huntington Beach, CA (US)

(21) Appl. No.: 11/641,386

(22) Filed: Dec. 18, 2006

(51) Int. Cl. H05B 3/68

(52) U.S. Cl. 219/460.1

(57) ABSTRACT

For a cooktop such as those associated with a stove or range, a dual coil heating element with a dedicated low temperature, low wattage coil for continuous operation when the heating element is in operation and a high wattage coil controlled by a graduated switch providing selective power application to the high wattage coil when the heating element is in operation.

### BACKGROUND OF THE INVENTION

The present invention is related broadly to cook top heating elements such as those found on a stove or range, and more particularly, to a dual coil heating element with a dedicated low temperature coil.

Stoves or ranges include cooktops having heating elements which may generally be gas or electric. Energy is applied to the heating elements causing them to provide heat. The heating elements may be exposed electric resistance coils, exposed flame, or, in the case of ceramic cook top, electric coils are disposed underneath a ceramic sheet.

In the case of electric coils, single coil elements must operate across a wide temperature range and therefore must accept a variable current which causes them to emit heat. Coils are typically rated or discussed in terms of their wattage. For example a high temperature coil may be rated at 3000 watts while operating on a range from 0-3000 watts.

When called upon to provide steady heating at a low temperature, such coils are operated at a correspondingly low wattage, such as 1100 watts, whereupon it turns out that high wattage coils are typically not up to the task of reliably providing the requisite low wattage environment, in that such high wattage coils are susceptible to instead undesirably providing uneven heat distribution, or unstable temperature control, or both. It would thus be advantageous to be able to provide a heating element configuration that can reliably provide the requisite low wattage environment to correspondingly provide a low temperature regime, such as a simmer, with even heat distribution and a reliable temperature control while at the same time also providing a capability for a high wattage environment.

### SUMMARY OF THE INVENTION

It is accordingly an object of the present invention to provide a heating element providing temperature stability and even heat distribution at both a low wattage environment and a high wattage environment.

It is another object of the present invention to provide such a heating element with basic mechanical controls.

The present invention includes a heating element having two coils. These coils include a first coil operational at a relatively low wattage with respect to a second coil which is operational at a relatively high wattage. It is preferable that the low wattage coil be operational at any time the heating element is operational.

The high wattage coil is exposed adjacent the low wattage coil such that both coils can effectively provide heat to a single cookware element. The second coil is in electrical communication with a switch that provides graduated power levels to the coil to provide graduated temperatures produced by the coil. The switch is in operational communication with a power source.

The low wattage coil is configured to remain energized whenever a primary power switch for the heating element is closed. Optionally, the power switch for the low wattage coil may be integrated with the graduated switch used for the high wattage coil to control the overall power to both coils.

Accordingly, one embodiment of the present invention is directed to a heating element for use in a cooktop including a first heating unit having a first wattage rating; a second heating unit having a second wattage rating greater than the first wattage rating; a main power switch for controlling main power to the first heating unit and the second heating unit; and a control assembly for providing selective temperature control to the second heating unit. The control assembly may include a graduated mechanical switch or a graduated electronic switch.

According to another embodiment, the present invention includes a heating element for use in a cooktop including a first heating unit having a first wattage rating; a second heating unit having a second wattage rating greater than the first wattage rating; and a control assembly for providing selective temperature control to the second heating unit and a power switch for controlling main power to the first heating unit and the second heating unit. The control assembly may include a graduated mechanical switch or a graduated electronic switch.

### BRIEF DESCRIPTION OF THE DRAWINGS

FIG. 1 is a schematic representation of a heating element according to a first preferred embodiment of the present invention; and

FIG. 2 is a schematic representation of a heating element according to s second preferred embodiment of the present invention.

### DESCRIPTION OF THE PREFERRED EMBODIMENTS

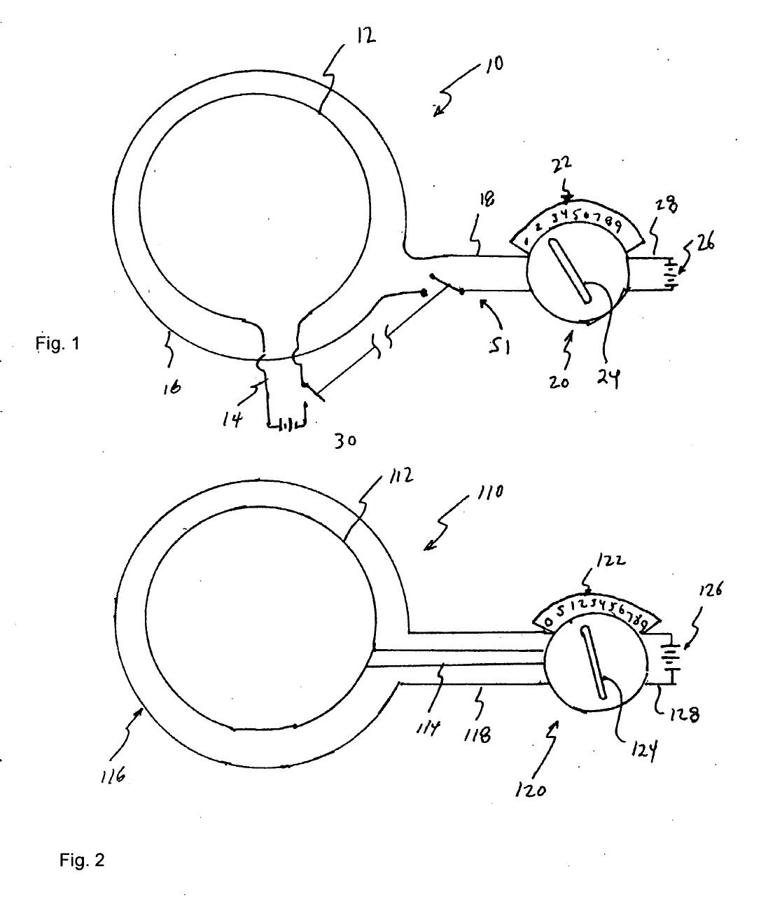

Turning now to the drawings, and more particularly to FIG. 1, a dual coil heating element with mechanical switches according to a first preferred embodiment thereof is illustrated generally at 10 and includes a low wattage heating coil 12 and a high wattage heating coil 16 disposed adjacent thereto. The coils 12, 16 are disposed in sufficiently close relation to transfer heat to a single piece of cookware. The low wattage coil 12 is connected to a power supply 26 by wiring 14 which includes a power switch S1 that acts as an on-off switch for the coil. The high wattage coil 16 is connected to a graduated switch 20 which may be a rotary switch that includes different switch positions 22 that are graduated to vary the power applied by the high wattage coil 16. The power switch S1 also controls overall power application to the high wattage coil 16. In this manner, the graduated switch 20 may be controlled by the power switch S 1 such that the high wattage coil 16 cannot operate unless the low wattage coil 12 is operational and the low wattage coil 12 remains operational any time the primary switch 30 is closed.

It will be apparent to those of ordinary skill in this art that an effective switch arrangement may be achieved without undue experimentation. The graduated switch 20 includes a handle 24 for selecting a desired temperature level. The graduated switch 20 is in electric communication with a power supply 26 via wiring 28. Two power supplies 26 are shown for simplicity; however, it will be understood that both coils 12, 16 are powered by a common power source.

Turning now to FIG. 2, a second preferred embodiment of the inventive heating element is generally designated as a heating element 110. The heating element 110 includes a low wattage coil 112 and a high wattage coil 116 in electrical communication with a graduated switch 120. Graduations 122 on the switch 120 include a position for the low wattage coil to be operational as well as an open position representing “off.” This all-inclusive switch 120 is in electrical communication with a power supply 126 using wiring 128 as will be apparent to those of ordinary skill in the electrical arts.

The herein-disclosed invention thus provides a dual coil heating element using economical mechanical switching and providing a stable temperature environment and even heat distribution.

I claim:

1. A heating element for use in a cooktop comprising:
a first heating unit having a first wattage rating;
a second heating unit having a second wattage rating greater than said first wattage rating;
a main power switch for controlling main power to said first heating unit and said second heating unit; and
a control assembly for providing selective temperature control to said second heating unit.

2. The heating element according to claim 1 wherein said control assembly includes a graduated mechanical switch.

3. The heating element according to claim 1 wherein said control assembly includes a graduated electronic switch.

4. A heating element for use in a cooktop comprising:
a first heating unit having a first wattage rating;
a second heating unit having a second wattage rating greater than said first wattage rating; and
a control assembly for providing selective temperature control to said second heating unit and a power switch for controlling main power to said first heating unit and said second heating unit.

5. The heating element according to claim 4 wherein said control assembly includes a graduated mechanical switch.

6. The heating element according to claim 4 wherein said control assembly includes a graduated electronic switch.
